(19) United States
(12) Patent Application Publication
(10) Pub. No.: US 2026/0142142 A1
(43) Pub. Date: May 21, 2026

(54) PRESODIATION METHOD FOR ANODE OF SODIUM-ION BATTERY BASED ON ELECTRODE FILM PREPARED BY DRY PROCESS

(71) Applicant: Baosheng (Suzhou) Energy Technology Co., Ltd, Suzhou, Jiangsu (CN)

(72) Inventor: Mingwen GAO, Suzhou, Jiangsu (CN)

(21) Appl. No.: 19/119,226

(22) PCT Filed: May 17, 2023
(86) PCT No.: PCT/CN2023/094744

§ 371 Date: Apr. 8, 2025

(30) Foreign Application Priority Data
Jun. 28, 2022 (CN) 202210738400.7

(51) Int. Cl. H01M 4/04; H01M 4/02; H01M 4/583; H01M 4/62

(52) U.S. Cl. CPC H01M 4/0435; H01M 4/0471; H01M 4/583; H01M 4/62; H01M 2004/027; H01M 2004/028

(57) ABSTRACT

A presodiation method for an anode of a sodium-ion battery based on an electrode film prepared by dry process includes following steps: (1) preparing an electrode material into a film, and lapping the film to obtain an electrode film; (2) applying a solvent to a surface of the electrode film obtained in step (1) and a surface of a metallic sodium, and then laminating same to obtain a composite film, (3) subjecting the composite film obtained in step (2) to a first rolling, laminating same with the electrode thin film again, and subjecting same to a second rolling; and (4) lapping the rolled composite film.

### CROSS-REFERENCE TO RELATED APPLICATIONS

This application is a National Stage Application of PCT application No. PCT/CN2023/094744, filed on May 17, 2023, which claims the priority and benefit of Chinese patent application No. 202210738400.7, filed on Jun. 28, 2022. The entireties of PCT application No. PCT/CN2023/094744 and Chinese patent application No. 202210738400.7 are hereby incorporated by reference herein and made a part of this specification.

### TECHNICAL FIELD

The disclosure relates to the field of sodium-ion batteries, and in particular to a presodiation method for an anode of a sodium-ion battery based on an electrode film prepared by dry process.

### BACKGROUND ART

The industrial application of sodium-ion batteries is still confronted with many problems. There are currently multiple options for the research of cathode materials for sodium-ion batteries. There is a variety of cathode materials, such as metal oxides, polyanion cathodes, Prussian blue, Prussian white and so on. However, hard carbon as the anode material for sodium-ion batteries is now a common choice in scientific research and industry. The difference lies mainly in the different methods for synthesizing hard carbon. At present, hard carbon materials are low-cost, have lower sodium embedding potential and higher theoretical capacity. They are ideal anode materials in the industrialization of sodium-ion batteries. However, similar to the problems that arise when hard carbon materials are used as anodes in sodium-ion batteries, hard carbon materials will still form SEI films during the first cycle of charging in sodium-ion batteries, and sodium ions will be stored in the structural defects of the hard carbon, which leads to a large irreversible initial capacity loss of the sodium-ion full-cell. In addition, due to intrinsic disordered structural defects of hard carbon, the hard carbon anode exhibits the characteristics of adsorbing and binding sodium in the first half of the sodium-ion full-cell charging. Therefore, there is no fixed electric potential platform. The half-cell discharge curve after this stage exhibits a platform caused by intercalation filling of sodium ion between graphene layers. Pre-supplementing the hard carbon anode with sodium ions can effectively reduce the consumption of sodium ions in the cathode material and solvent, thus the cycle life of the sodium-ion battery is significantly extended, which is of great significance for the industrial application of sodium-ion batteries.

Analogous to the prelithiation process of lithium-ion batteries, many industrialization problems in the presodiation process have not been completely solved. Compared with metallic lithium, metallic sodium lacks the protection by a surface passivation layer. Metallic sodium is more reactive, and its stability in air is worse. It is more dangerous in actual application and production. Compared with prelithiation, using metallic sodium for presodiation is more difficult. Therefore, the work of presodiation is less carried out, and mainly focused on the cathode presodiation. There are only a handful of studies on the process of presodiation of anode hard carbon.

As described in CN113178548A, the graphite anode sheet is pretreated using a film-forming agent. In particular, sodium polycyclic aromatic hydrocarbons are used to generate an SEI layer on the surface of the graphene anode. This method has limited effect on the presodiation of hard carbon, since the structural defects inside the hard carbon will continue to consume sodium ions in the solution. The mechanical presodiation method is mentioned in CN111952532A or CN107240715A, where the metallic sodium sheet and the metal anode material are compounded into an alloy by rolling, or into anode sheet with traditional wet coating and then statically pressed with metallic sodium. This method is not suitable for large-scale operation for battery structures mainly using hard carbon as the anode, but it proves that metallic sodium and hard carbon can react in contact and undergo alloying and presodiation. As another example, CN113113235A describes that in a sodium-ion capacitor, sodium salt is added to the solution for presodiation before use. The added sodium salt decomposes into CO2 gas and metallic sodium during the first charging process. This method is suitable for capacitor materials such as activated carbon or graphene as the cathode material. For crystalline materials, corresponding side reactions will occur at the cathode.

In view of the problems in the existing technology, there is an urgent need to find a simple, efficient and low-cost presodiation method for the anode of sodium-ion batteries that facilitate to carry out large-scale production and manufacturing.

### SUMMARY

In view of the problems in the existing technology, the present disclosure provides a presodiation method for an anode of a sodium-ion battery based on an electrode film prepared by dry process. The method uses a dry electrode film-forming manner where an active substance is pre-fiberized with a powdered mixed binder, and then rolled to form a self-supporting film. It is then rolled and laminated with metallic sodium. During this process, the difference of electric potential between the metallic sodium and the hard carbon anode will cause spontaneous sodium insertion reaction. Alternatively, spraying a small amount of sodium-ion solvent before rolling can accelerate the reaction between the metallic sodium and the self-supporting film of active material. In addition, the electrode film that has been laminated with the sodium sheet is further rolled and laminated with the other two self-supporting films to provide secondary protection for the presodiated electrode. The method is convenient for large-scale production and manufacturing.

In order to achieve the above-mentioned purpose of the disclosure, a presodiation method is provided, which includes following steps:
(1) preparing an electrode material into a self-supporting electrode film by a dry method and then lapping to obtain a plurality of electrode film roll;
(2) directly laminating the self-supporting electrode film obtained in the step (1) with a metallic sodium, or spraying a small amount of solvent on its surface and laminating with the metallic sodium to obtain a composite film;
(3) performing a first rolling to the composite film obtained in the step (2), and then laminating with the electrode film of the step (1) and performing a second rolling;
(4) lapping the rolled composite film.

Furthermore, the mass ratio of the electrode material to the metallic sodium can be adjusted according to the film thickness of the low-temperature dry electrode and the thickness of the metallic sodium sheet, sodium band or sodium mesh band, or according to the number of rolling times. The preferred number of compounding and rolling times is twice.

Furthermore, the metallic sodium in the step (2) includes a sodium sheet, a sodium band and/or a sodium mesh band.

Furthermore, the electrode material in the step (1) includes a cathode material or an anode material, the cathode material includes a metal oxide material, specifically includes one or more of a polyanion cathode, Prussian blue and Prussian white; the anode material includes one or more of hard carbon, soft carbon, activated carbon and mesocarbon microbeads MCMB.

Furthermore, the electrode material includes one or more of activated carbon, hard carbon, soft carbon and mesocarbon microbeads MCMB.

Furthermore, performing a blowing protection with a protective gas before laminating the electrode film and the metallic sodium in the step (2).

Furthermore, the thickness of the film in the step (1) is 10 micrometers-2 millimeters. Preferably the thickness is 100 micrometers.

Furthermore, the environmental humidity of lamination is less than 50RH.

Furthermore, the thickness of the metallic sodium in the step (2) is 5 micrometers-2 centimeters. Preferably, the thickness of the metallic sodium in the step (2) is 200 micrometers.

Furthermore, the solvent in the step (2) includes an organic non-aqueous solvent.

Preferably, the solvent includes one or more of a cyclic carbonate solvent such as ethylene carbonate (EC) and propylene carbonate (PC); or a chain carbonate solvent such as diethyl carbonate (DEC), dimethyl carbonate (DMC) and ethyl methyl carbonate (EMC) or a combination thereof. Preferably, the solvent is EC, DEC and DMC in a volume ratio of 1:1:1.

Furthermore, a time interval between the first rolling and the second rolling in the step (3) is 1 second to 1 week. Preferably, the time interval between the first rolling and the second rolling is 3 minutes.

Furthermore, a temperature of the rollings in the step (3) is −40˜120° C., and a number of times of the rollings is 1-10. Preferably, the temperature of the rollings is 60° C.

Furthermore, adjusting a thickness of the first rolling in the step (3) to 200 micrometers
2 centimeters, and adjusting a thickness of the second rolling in the step (3) to 20 micrometers-200 micrometers.

Preferably, adjusting the thickness of the first rolling in the step (3) is to 200 micrometers, and adjusting the thickness of the second rolling in the step (3) to 150 micrometers.

In some specific implementations, the presodiation method includes the following steps:
(1) after the active anode material of the sodium-ion battery is prepared into a self-supporting film with a certain mechanical strength by a dry process, it is not laminated with the current collector at first, but lapped independently. The film thickness is 10 micrometers to 2 millimeters. The preferred film thickness is 100 micrometers.
(2) laminating the electrode film of sodium-ion anode, such as a self-supporting hard carbon or soft carbon prepared by a dry process, with a sodium sheet, a sodium band or a sodium mesh band. The preferred composite thickness of the sodium sheet, sodium band or sodium mesh band is 200 micrometers, and its composite structure is shown in FIG. 1. The environment humidity of lamination is less than 50RH.
(3) alternatively, before the dry prepared self-supporting sodium-ion anode film is laminated with a sodium sheet, a sodium band or a sodium mesh band, a proper amount of a solvent suitable for the sodium-ion battery is sprayed on the contact surface between the self-supporting sodium-ion anode film and the sodium sheet, the sodium band or the sodium mesh band. The solvent is an organic non-aqueous solvent. Then it is laminated with the sodium sheet, the sodium band or the sodium mesh band. The preferred composite thickness of the sodium sheet, sodium band or sodium mesh band is 200 micrometers, and the composite structure is shown in FIG. 2. The environment humidity of lamination is less than 50RH. Before rolling the sodium electrode and the sodium sheet, performing a blowing protection with protective gas such as nitrogen, argon or the like. The preferred gas is nitrogen. The composite film is rolled 1-10 times by a roller press at a temperature from −40 to 120° C., preferably at 80° C. The thickness of the first rolling is preferably adjusted to 200 micrometers. The rolled composite film is laminated with a 100 micrometers thick active material dry process self-supporting film again, the material of which can be the same as or different from the active substance of the self-supporting film of the first rolling and composite. If the self-supporting film before the first laminating and rolling with the sodium band is a hard carbon material, then the self-supporting film of the second laminating and rolling can be a hard carbon material or an activated carbon, a soft carbon and other sodium battery anode materials. The second rolling thickness is 150 micrometers. The time interval between the first rolling and the second rolling varies from 1 second to 1 week, and the preferred time interval is 3 minutes. The rollers of the roller press can be made of metal or plastic, preferably metal steel.
(4) the rolled composite electrode is lapped and sealed for storage at a sealing temperature from −40° C.˜100° C. in a dry environment.

The beneficial technical effects of the present disclosure are in that:
1. The presodiation method of the present disclosure is simple, efficient and low in terms of cost. There are no similar technologies and methods before.
2. The self-supporting dry electrode film surface is sprayed with solvent and then rolled and laminated with metallic sodium, which is new compared with the existing technology, and greatly improves the presodiation efficiency to make the best of the advantages and characteristics of the self-supporting dry electrode.
3. The presodiation method is safe and efficient, and has moderate environmental requirements, since the metallic sodium band is covered and protected by the active material after being released from the reel.
4. This method can roll the metallic sodium band to any thickness, so that the mass ratio of metallic sodium to active material can be accurately adjusted. There is currently no same or similar method.
5. This method can be used for almost all powdered electrode materials. As long as the material can be formed into a film by a low-temperature with dry method, the material can be used for presodiation, and its practical application range is extremely wide.
6. This method can be used for structural lamination of different kinds of electrode films as required, and simultaneous presodiation to meet the special needs of energy storage devices such as sodium-ion batteries and sodium-ion capacitors.
7. Presodiation and lamination using different types of active materials can be realized with this method, so as to achieve the effect of different types of active materials synergistically storing sodium ions. The material of the self-supporting film of the second laminating and rolling can be the same as or different from the active substance of the self-supporting film of the first laminating and rolling. If the self-supporting film before the first laminating and rolling with the sodium band is a hard carbon material, the self-supporting film of the second laminating and rolling can be a hard carbon material or an activated carbon, a soft carbon and other sodium battery anode materials.

### BRIEF DESCRIPTION OF THE DRAWINGS

FIG. 1 is a schematic diagram of a dry electrode film being laminated with metallic sodium and then laminated with a dry electrode film again.

FIG. 2 is a schematic diagram showing that the dry electrode film is rolled and thinned again by itself after being laminated with metallic sodium.

FIG. 3 is a schematic diagram of a dry electrode film being laminated with metallic sodium and then repeatedly rolled and laminated with a dry self-supporting electrode film.

In particular, in FIGS. 1-3, 1—sodium-ion battery anode material dry self-supporting film, 2—sodium band, sodium sheet or sodium mesh band, 3—composite electrode roll, 4—protective gas, 5—first rolling, 6—second rolling, 7—solvent.

FIG. 4 is a half-cell performance curve diagram of the hard carbon anode charging and discharging to the metallic sodium. In particular, (a) is a half-cell performance curve diagram of the hard carbon anode without presodiation charging and discharging to the metallic sodium, and (b) is a half-cell performance curve diagram of the hard carbon anode with presodiation charging and discharging to the metallic sodium.

FIG. 5 is a sodium-ion full-cell performance curve diagram of the hard carbon anode with/without presodiation for charging and discharging to the ternary cathode material.

### DETAILED DESCRIPTION

The following describes embodiment of the present disclosure through specific examples. Those skilled in the art can easily understand other advantages and effects of the present disclosure from the contents disclosed in this specification. The present disclosure may also be implemented or applied through other different specific implementation methods, and the details in this specification may also be modified or changed in various ways based on different viewpoints and applications without departing from the spirit of the present disclosure.

Before further describing the embodiment of the present disclosure, it should be understood that the scope of protection of the present disclosure is not limited to the specific embodiment described below. It should also be understood that the terms used in the examples of the present disclosure are for describing the specific embodiment rather than for limiting the scope of protection of the present disclosure.

When numerical ranges are given in the embodiment, it should be understood that both endpoints of each numerical range and any numerical value between the two endpoints can be selected unless otherwise specified in the present disclosure. Unless defined otherwise, all technical and scientific terms used herein have the same meaning as commonly understood by one of ordinary skill in the art to which this disclosure belongs.

It is worth noting that, the raw materials used in the present disclosure are all common commercially available products, so their sources are not specifically limited.

### Example 1

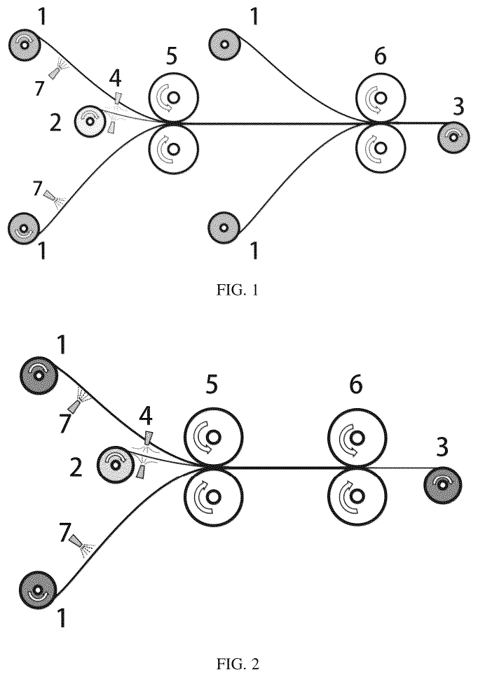

This example was a simple presodiation process of a single active electrode material, which specifically included the following steps:
(1) the hard carbon electrode material was prepared into a film with a certain mechanical strength by a low-temperature dry process, and lapped. The film thickness was 200 micrometers.
(2) the hard carbon electrode film was laminated with sodium mesh band. The thickness of the sodium mesh band was 200 micrometers, and its composite structure is shown in FIG. 1. The environment humidity of lamination was less than 50RH. In addition, before the hard carbon electrode was laminated, the contact surface with the sodium band was sprayed with a solvent suitable for sodium-ion batteries, which was an organic non-aqueous solvent combination of EC:DEC:DMC=1:1:1 (volume ratio). Before the sodium mesh band and the hard carbon electrode were laminated and rolled, the blowing protection was performed with nitrogen protective gas.
(3) the hard carbon sodium band composite film was performed the first rolling on a roller press at a temperature of 80° C. The thickness for the first rolling was adjusted to 300 micrometers. The rolled composite film was laminated with a hard carbon self-supporting film with a thickness of 100 micrometers again, and the thickness for the second rolling was 200 micrometers. The time interval between the first rolling and the second rolling was 3 minutes. The rollers of the roller press are made of chromium-plated stainless steel.
(4) the rolled composite electrode was lapped and sealed for storage at a sealing temperature of 25° C. in a dry environment. The specific effect of the half-cell is shown in FIG. 4.

### Example 1A

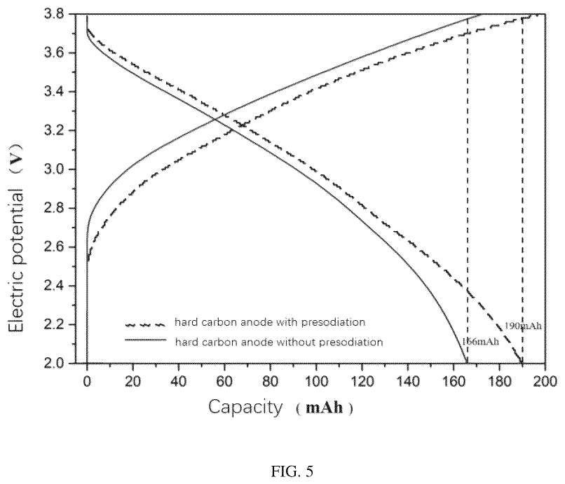

A battery with a cathode of ternary sodium salt oxide and an anode of hard carbon with presodiation (Example 1). The full-cell performance is shown in FIG. 5.

### Example 2

This example was that a single active electrode material was performed the presodiation for the first time and then rolled again to ensure a higher mass ratio of metallic sodium in the active material, which specifically included the following steps:
(1) the activated carbon was prepared into a self-supporting film with a certain mechanical strength by a low-temperature dry process, and lapped. The film thickness was 200 micrometers.
(2) the activated carbon electrode film was laminated with sodium mesh band. The thickness of the sodium band was 200 micrometers, and its composite structure is shown in FIG. 2. In addition, before the activated carbon electrode was laminated, the contact surface with the sodium band was sprayed with a solvent suitable for sodium-ion batteries, which was an organic non-aqueous solvent combination of EC:DEC:DMC=1:1:1 (volume ratio). Before the sodium band and the activated carbon electrode were laminated and rolled, the blowing protection was performed with nitrogen protective gas.
(3) the composite film was performed the first rolling by a roller press at a temperature of 40° C. The thickness of the first rolling is adjusted to 300 micrometers. The thickness of the second rolling was adjusted to 150 micrometers. The time interval between the first rolling and the second rolling was 3 minutes. The rollers of the roller press are made of chromium-plated stainless steel.
(4) the rolled composite electrode was lapped and sealed for storage at a sealing temperature of 25° C. in a dry environment.

### Example 3

This example was the presodiation after multiple electrode mixed materials uniform compounded, which specifically included the following steps:
(1) the soft carbon and hard carbon electrode material were respectively prepared into a film with a certain mechanical strength by a low-temperature dry process, and lapped. The film thickness was 100 micrometers.
(2) the hard carbon electrode film was laminated with sodium band. The thickness of the sodium band was 500 micrometers, and its composite structure is shown in FIG. 2. The environment humidity of lamination was less than 50RH. Before the sodium band and the hard carbon electrode film were laminated and rolled, the blowing protection was performed with nitrogen. Before the hard carbon electrode was laminated, the contact surface with the sodium band was sprayed with a solvent suitable for sodium-ion batteries, which was an organic non-aqueous solvent combination of EC:DEC:DMC=1:1:1 (volume ratio).
(3) the hard carbon and sodium band composite film was performed the first rolling on a roller press at a temperature of 80° C. The thickness for the first rolling was adjusted to 450 micrometers. The rolled composite film was laminated with a soft carbon dry self-supporting electrode film with a thickness of 100 micrometers again, and the thickness for the second rolling was 300 μm. The time interval between the first rolling and the second rolling was 3 minutes. The rollers of the roller press were made of chromium-plated stainless steel.
(4) the rolled composite electrode was lapped and sealed for storage at a sealing temperature of 25° C. in a dry environment.

### Example 4

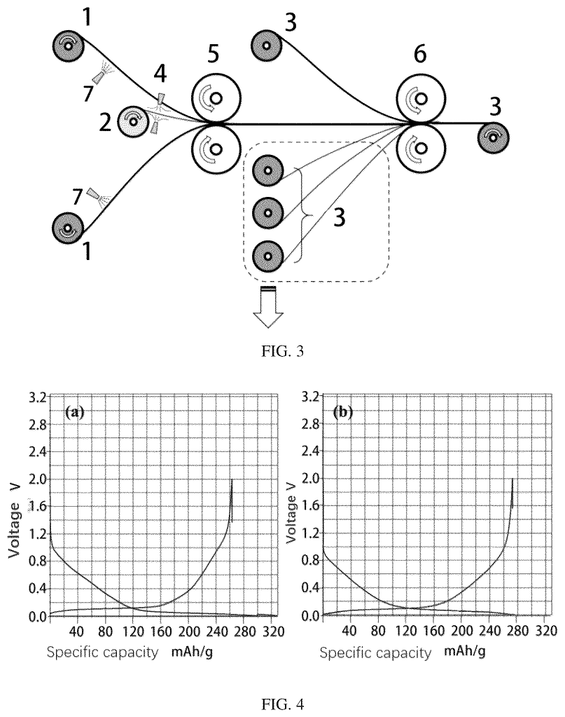

In this example, a multi-level composite of active materials and metallic sodium was formed by a plurality of rollings, so as to form a presodiated electrode with a very uniform and fine structure, which specifically included the following steps:
(1) the hard carbon electrode material was prepared into a film with a certain mechanical strength by a low-temperature dry process, and lapped. The film thickness was 200 micrometers.
(2) the hard carbon electrode film was laminated with sodium mesh band. The thickness of the sodium mesh band was 200 micrometers, and its composite structure is shown in FIG. 3. The environment humidity of lamination was less than 50RH. Before the sodium mesh band and the hard carbon electrode film were laminated and rolled, the blowing protection was performed with nitrogen protective gas. In addition, before the hard carbon electrode was laminated, the contact surface with the sodium band was sprayed with a solvent suitable for sodium-ion batteries, which was an organic non-aqueous solvent combination of EC:DEC:DMC=1:1:1 (volume ratio).
(3) the hard carbon sodium band composite film was performed the first rolling by a roller press at a temperature of 80° C. The thickness of the rolling was adjusted to 300 micrometers. The composite film was divided into one roll, two rolls, three rolls or more rolls as required, as shown in the dotted line of FIG. 3.
(4) One roll, two rolls, three rolls or more rolls of the composite film were laminated and rolled together again, preferably three rolls were laminated and rolled together. The rolling thickness was adjusted to 500 micrometers. The composite film was then rolled again through a roller press at multiple stages to a thickness of 150 micrometers. At this time, the layered structure of the hard carbon active material and metallic sodium of the electrode was uniform and fine.
(5) the rolled composite electrode was lapped and sealed for storage at a sealing temperature of 25° C. in a dry environment.

### Example 5

In this example, a multi-level composite of cathode active materials and metallic sodium was formed by a plurality of rollings, so as to form a presodiated electrode with a very uniform and fine structure, which specifically included the following steps:
(1) the cathode ternary sodium salt oxide electrode material was prepared into a film with a certain mechanical strength by a low-temperature dry process, and lapped. The film thickness was 100 micrometers.
(2) the cathode ternary sodium salt oxide electrode material film was laminated with sodium band. The thickness of the sodium band was 500 micrometers, and its composite structure is shown in FIG. 2. In addition, before the cathode ternary sodium salt oxide electrode material was laminated, the contact surface with the sodium band was sprayed with a solvent suitable for sodium-ion batteries, which was an organic non-aqueous solvent combination of EC:DEC:DMC=1:1:1 (volume ratio). Before the sodium sheet and the cathode ternary sodium salt oxide electrode film were rolled, the blowing protection was performed with nitrogen.
(3) The cathode ternary sodium salt oxide electrode film and the sodium band composite film were performed the first rolling through a roller press at a temperature of 70° C. The rolling thickness was adjusted to 450 micrometers. The rolled sodium band composite film was laminated with the ternary cathode sodium band composite film with a thickness of 450 micrometers again. This composite can be two layers of ternary cathode sodium band composite film, or more than two layers of ternary cathode sodium band composite film, which was adjusted according to needs and actual conditions, as shown in the dotted line part of FIG. 3. The second rolling thickness was 750 micrometers, or it can be adjusted again as needed. The time interval between the first rolling and the second rolling was 3 minutes. The rollers of the roller press were made of chromium-plated stainless steel.
(4) the rolled composite electrode was lapped and sealed for storage at a sealing temperature of 25° C. in a dry environment.

### Comparative Example 1

The only difference from Example 1 was that the hard carbon of the electrode material was without presodiation. The specific effect of the half-cell is shown in FIG. 4.

### Comparative Example 1A

The only difference from Example 1A was that the hard carbon of electrode material was without presodiation. The specific effect of the full-cell is shown in FIG. 5.

### Comparative Example 2

The only difference from Example 2 was that the activated carbon was presodiated without spraying the solvent EC:DEC:DMC=1:1:1.

### Test Method:

The half-cell cathode used in the experiment was a composite electrode with presodiation. The anode was a metallic sodium sheet. The electrolyte was 1 mol·L-1 NaPF6 in the solvent EC:DEC:DMC=1:1:1 (volume ratio). The electrode charging and discharging window was 0V-2.0V. The charging and discharging rate was 0.1C.

In particular, the electrochemical tests of Example 1, Example 2, Example 3, Example 4, Example 5 and Comparative Example 1 were all half-cells whose counter electrode was metallic sodium.

The full-cell cathode used in the experiment was a ternary sodium salt oxide. The anode was a hard carbon electrode with presodiation. The electrolyte was 1 mol. L-1 NaPF6 in the solvent EC:DEC:DMC=1:1:1 (volume ratio). The electrode charging and discharging window was 2.0V-3.8V. The charging and discharging rate was 0.1C.

In particular, Example 1A was a full-cell with a cathode of ternary sodium salt oxide and an anode of presodiated hard carbon. The electrochemical test of Comparative Example 1A was a full-cell with a cathode of ternary sodium salt oxide and an anode of hard carbon without presodiation.

In the activated carbon stripping experiment, tape was evenly applied to both sides of the electrode and then torn off at a constant speed. The state of metallic sodium in the activated carbon interlayer was observed. In particular, the activated carbon which was performed the presodiation with a solvent in Example 2 had no metallic sodium in the middle after being torn apart for 5 hours, while the activated carbon in Comparative Example 2 still had metallic sodium residues after being torn apart for 5 hours.

TABLE 1

| | Initial efficiency | | |
|---|---|---|---|
| Examples | of Anode | Specific capacity | |
| Example 1: | 98% | 270 | mAh/g |
| Example 1A | 97% | 80 | mAh/g |
| Example 2: | 110% | 82 | mAh/g |
| Example 3: | 95% | 220 | mAh/g |
| Example 4: | 98% | 280 | mAh/g |
| Example 5: | 97% | 120 | mAh/g |
| Comparative Example 1 | 80% | 270 | mAh/g |
| Comparative Example 1A | 92% | 73 | mAh/g |

| | | |
|---|---|---|
| Comparative Example 2 | none | none |

It should be noted that the above content is only used to illustrate the present disclosure, rather than to limit the scope of protection of the present disclosure. Simple modifications or equivalent substitutions of the present disclosure by ordinary skilled in the art do not deviate from the essence and scope of the present disclosure.

1. A presodiation method, comprising following steps:
(1) preparing an electrode material into a film and then lapping the film to obtain an electrode film;
(2) applying a solvent to a surface of the electrode film obtained in the step (1) and a surface of a metallic sodium, and then laminating the electrode film and the metallic sodium to obtain a composite film;
(3) performing a first rolling to the composite film obtained in the step (2), and then laminating with the electrode film and performing a second rolling to obtained a rolled composite film; and
(4) lapping the rolled composite film.

2. The presodiation method according to claim 1, wherein the metallic sodium in the step (2) comprises at least one of a sodium sheet, a sodium band or a sodium mesh band.

3. The presodiation method according to claim 1, wherein the electrode material in the step (1) comprises a cathode material or a anode material, the cathode material comprises a metal oxide material, and the anode material comprises one or more of hard carbon, soft carbon, activated carbon or mesocarbon microbeads (MCMB).

4. The presodiation method according to claim 1, comprising performing a blowing protection with a protective gas before laminating the electrode film and the metallic sodium in the step (2).

5. The presodiation method according to claim 1, wherein a thickness of the film in the step (1) is 10 micrometers-2 millimeters.

6. The presodiation method according to claim 1, wherein a thickness of the metallic sodium in the step (2) is 5 micrometers-2 centimeters.

7. The presodiation method according to claim 1, wherein the solvent in the step (2) comprises an organic non-aqueous solvent.

8. The presodiation method according to claim 1, wherein a time interval between the first rolling and the second rolling in the step (3) is 1 second to 1 week.

9. The presodiation method according to claim 1, wherein a temperature of the first rolling and the second rolling in the step (3) is −40-120° C.

10. The presodiation method according to claim 1, comprising adjusting a thickness of the first rolling in the step (3) to 200 micrometers-2 centimeters, and adjusting a thickness of the second rolling in the step (3) to 20 micrometers-200 millimeters.

11. The presodiation method according to claim 3, wherein the cathode material comprises one or more of a polyanion cathode, Prussian blue, or Prussian white.

12. The presodiation method according to claim 9, wherein a number of times of the rollings is 1-10.
